(19) United States
(12) Patent Application Publication
(10) Pub. No.: US 2024/0199263 A1
(43) Pub. Date: Jun. 20, 2024

(54) BAGGING METHOD AND BAGGING APPARATUS

(71) Applicant: PACRAFT Co., Ltd., Tokyo (JP)

(72) Inventor: Koichi NAKAGAWA, Yamaguchi-ken (JP)

(21) Appl. No.: 18/542,160

(22) Filed: Dec. 15, 2023

(30) Foreign Application Priority Data
Dec. 16, 2022 (JP) 2022-201486

(51) Int. Cl. B65B 61/26; B41J 3/407; B41M 5/00; B65B 43/26; B65B 43/46; B65B 61/24

(52) U.S. Cl. CPC B65B 61/26; B41J 3/407; B41M 5/0047; B41M 5/0088; B65B 43/26; B65B 43/465; B65B 61/24

(57) ABSTRACT

A bagging method includes the steps of: introducing a content into an inside of a bag; making at least a portion of a printing surface of the bag curved; and performing printing on the printing surface including a curved surface with use of a printing device having a curved surface printing function.

### CROSS-REFERENCE TO RELATED APPLICATIONS

This application is based upon and claims the benefit of priority from Japanese Patent Application No. 2022-201486, filed on Dec. 16, 2022; the entire contents of which are incorporated herein by reference.

### TECHNICAL FIELD

The present disclosure relates to a bagging method and a bagging apparatus.

### BACKGROUND ART

In bagging methods and bagging apparatuses, various types of information (e.g., a date of manufacture and an expiration date) may be printed on a bag, in addition to a process of introducing food products, daily necessities, or other contents inside the bag.

In order to properly perform such a printing process on a bag, printing processing is generally performed on a bag placed in a flattened state (see Japanese utility-model application publication No. 4-60811). This is because a printing surface (specifically, an outer surface of a bag) having a state of flat during a printing processing makes the printing processing itself easier and is advantageous for achieving a high-quality printing condition. To ensure such a flattened state of a bag, a printing process is performed before the mouth portion of the bag is opened (and thus before contents are introduced inside the bag).

### SUMMARY OF THE INVENTION

It is difficult sometimes to install a printing device upstream, in a bagging apparatus, from an opening device that opens the mouth portion of a bag because of the specifications of the bagging apparatus, the installation space for the printing device and the layout of the various devices (for instance, the positional relation between the position where a bag is supplied to the bagging apparatus and the position where contents are introduced into the bag). In this case, the printing process cannot be performed before the mouth portion of the bag is opened.

When it is not possible to perform a printing process before the mouth portion of a bag is opened, the bag is conventionally fed to a bagging apparatus after being printed on the bag by a human. In this case, the burden on a worker performing the printing operation is high, and the printing operation becomes a bottleneck, making it difficult to improve the productivity of bags (i.e., product bags) with contents sealed in them.

It is also conceivable to automatically and continuously perform a printing process and a bagging process by installing a printing device as a separate device from a bagging apparatus, installing the printing device upstream from the bagging apparatus, and mechanically supplying to the bagging apparatus bags that have been subject to the printing processing by the printing device. In this case, however, it is required to install a mechanism for sending bags one by one toward a printing position, a mechanism for positioning bags at the printing position, and a mechanism for sending bags toward the bagging apparatus after the printing processing in addition to the printing device, resulting in higher costs and a larger size of the overall system. In particular, when the installation space for devices is limited, it may not be possible to properly install both a printing device and a bagging apparatus that are provided as separate devices.

Further, in a case where a bagging process is performed after a printing process, bags that have been properly subject to the printing process but have not properly been subject to the bagging process may be produced. For example, after time information, such as a date of manufacture or an expiration date, is properly printed on a bag in a printing process, an inadequate opening of the mouth portion of the bag and/or an inadequate introduction of contents into the bag may occur in the bagging process. Bags that have not been properly subject to a bagging process in this manner should preferably be reused for the bagging process whenever possible, but bags that have already been printed with time information (in particular, time information that is variably determined according to a timing when the bagging process is actually performed) are subject to the time limit on reuse according to the time information that has been actually printed. For example, in a case of reusing a bag on which a date of manufacture, an expiration date, etc. are printed, the bag may be required to be reused in the bagging process on the same day as the day when the printing process is performed. In this case, bags that are not reused in the bagging process during the same day as the day when the printing process takes place may ultimately have to be discarded because it is difficult to reuse them at a later date.

The present disclosure has been made in view of the above-mentioned circumstances, and an object thereof is to provide a technology advantageous for carrying out high-quality printing on a printing surface of a bag.

One aspect of the present disclosure is directed to a bagging method including the steps of: introducing a content into an inside of a bag; making at least a portion of a printing surface of the bag curved; and performing printing on the printing surface including a curved surface with use of a printing device having a curved surface printing function.

The bagging method may include the step of opening a mouth portion of the bag, wherein the content may be introduced into the inside of the bag through the mouth portion being in an open state after the mouth portion is opened and before the printing is performed on the printing surface.

The curved surface may have a predetermined shape by a curved surface forming device exerting a force on the bag.

The bag may be intermittently conveyed, and the printing on the printing surface may be performed while the bag is intermittently stopped.

Both side portions of the bag may be held by a pair of holding devices in such a manner that the bag may be held in a suspended state by the pair of holding devices.

Another aspect of the present disclosure is directed to a bagging apparatus comprising: a content introduction device that introduces a content into an inside of a bag; a curved surface forming device that makes at least a part of a printing surface of the bag curved; and a printing device that has a curved surface printing function and performs printing on a printing surface that includes the curved surface.

The bagging apparatus may comprise a mouth opening device that opens a mouth portion of the bag, wherein the content introduction device may introduce the content into the inside of the bag through the mouth portion being in an open state after the mouth portion is opened by the mouth opening device and before the printing is performed on the printing surface by the printing device.

The bagging apparatus may comprise holding devices forming a pair that hold both side portions of the bag, a distance between the holding devices forming a pair being variable, the printing surface of the bag being deformed depending on the distance between the holding devices forming a pair, wherein the curved surface forming device may include the holding devices forming a pair, and the distance between the holding devices forming a pair is included in an allowable spacing range when the printing device performs the printing on the printing surface in such a manner that at least a part of the printing surface has a curved surface shape that the curved surface printing function allows.

The curved surface forming device may have a shape forming support unit that contacts an outer surface of the bag to make at least a portion of the printing surface the curved surface, and the printing device may perform the printing on the printing surface in a state where the shape forming support unit is in contact with the outer surface of the bag.

The curved surface forming device may have a shape forming support unit that contacts an inner surface of the bag to make at least a part of the printing surface the curved surface, and the printing device may perform the printing on the printing surface in a state where the shape forming support unit is in contact with the inner surface of the bag.

The bag may have a bottom portion that is able to be unfolded, the printing surface of the bag being deformed according to an unfolded state of the bottom portion, the curved surface forming device may have a shape forming support unit that places the bottom portion of the bag in a predetermined unfolded state to make at least a part of the printing surface the curved surface, and the printing device may perform the printing on the printing surface in a state where the bottom portion of the bag is placed in the predetermined unfolded state.

The shape forming support unit may include: a first support member that contacts a first lateral face body forming a front outer surface of the bag; and a second support member that contacts a second lateral face body forming a back outer surface of the bag, and the printing surface may be included in at least one of the front outer surface and the back outer surface of the bag.

The bagging apparatus may comprise a conveyance device that intermittently conveys the bag along a conveyance route that includes a curved path at least in part, and the printing device may perform the printing on the printing surface while the bag is intermittently stopped in the conveyance route.

The bagging apparatus may comprise holding devices forming a pair that hold both side portions of the bag in such a manner that the bag is held in a suspended state.

According to the present disclosure, it is advantageous to perform high-quality printing on a printing surface of a bag.

### BRIEF DESCRIPTION OF DRAWINGS

FIG. 1 is an oblique perspective view showing a schematic configuration of an example of a bagging apparatus;

FIG. 2 is an oblique perspective view showing an example of a printing device and a shape forming support unit;

FIG. 3 is an oblique perspective view showing another example of a printing device and a shape forming support unit; and

FIG. 4 is an oblique perspective view showing another example of a printing device and a shape forming support unit.

### DETAILED DESCRIPTION

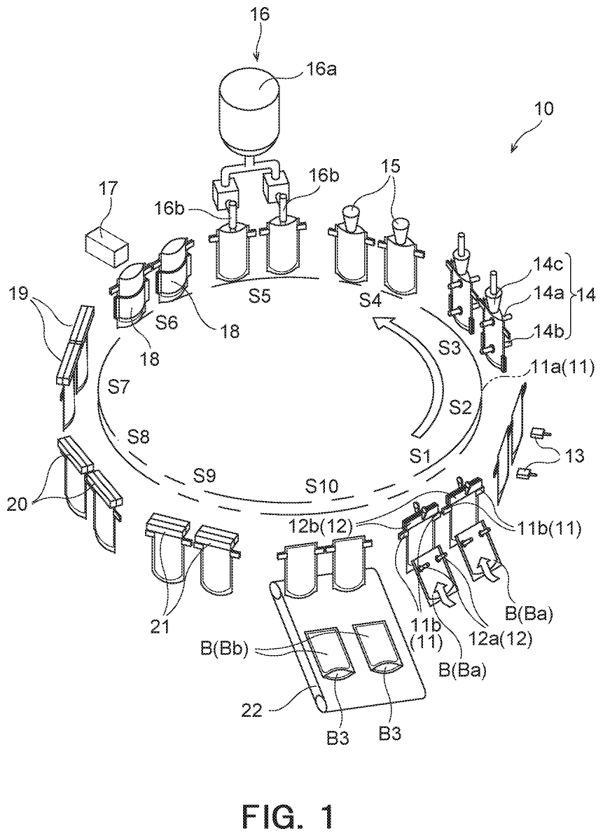

FIG. 1 is an oblique perspective view showing a schematic configuration of an example of a bagging apparatus 10.

Bags B used in the present embodiment are self-standing bags that are each able to stand on their own, and each have a bottom portion B3 that can be folded and unfolded. In a case where a bag B has a form of a flat bag Ba, the bottom portion B3 is placed in a folded state, while in a case where a bag B has a form of a product bag Bb, the bottom portion B3 is placed in an unfolded state. Bags B are supplied to the bagging apparatus 10 in a form of flat bags Ba, and their bottom portions B3 are placed in an unfolded state while a mouth opening process, a content introduction process and a printing process described below are performed in the bagging apparatus 10.

The bagging apparatus 10 comprises a conveyance device 11, a bag supplying device 12, a variety inspection device 13, a mouth opening device 14, a solid material feeding device 15, a liquid injection device 16, a printing device 17, a shape forming support unit 18, a first heat sealing device 19, a second heat sealing device 20, a cooling seal device 21, and a carry-out conveyor 22.

The conveyance device 11 is a device that intermittently conveys bags B along a conveyance route. The conveyance device 11 of the present example, which is an intermittent rotary-type conveyance device, comprises: a rotary table 11a that is rotated intermittently by a driving device (not shown) such as a motor; and a plurality of grippers 11b that are attached to the periphery of the rotary table 11a. The plurality of grippers 11b move along a predetermined conveyance route in response to the intermittent rotation of the rotary table 11a, so that a plurality of bags B held by the plurality of grippers 11b are intermittently conveyed along the conveyance route.

The conveyance route in the example shown in FIG. 1 is entirely formed by a curved path (specifically, a circular path) but the shape of the conveyance route is not limited. The conveyance device 11 may convey bags B along a conveyance route that includes a curved path at least in part or may convey bags B along a conveyance route that does not include a curved path.

In the example shown in FIG. 1, two grippers 11b forms one gripper pair, and each gripper pair (i.e., a pair of grippers 11b (a pair of holding devices)) holds both side portions of a bag B, so that the bag B is held in a suspended state by the pair of grippers 11b. The space interval between grippers 11b of each gripper pair is variable, and the front-side outer surface and the back-side outer surface of a bag B held by a pair of grippers 11b are deformed depending on the spacing between the pairs of grippers 11b.

The conveyance device 11 shown in FIG. 1 conveys bags B intermittently and stops the bags B intermittently at a first station S1 through a tenth station S10 in sequence. In particular, the conveyance device 11 of the present example is a W-type (i.e., double-row type) conveyance device that stops two bags B at a time at each of the first station S1 through the tenth station S10. Ten gripper units, each of which is formed by two gripper pairs, are provided, and these ten gripper units are mounted onto the outer circumference portion of the rotary table 11a at equal intervals in the circumferential direction (i.e., at equal angular intervals with respect to the central axis (i.e., the rotation axis) of the rotary table 11a).

At the first station S1, the bag supplying device 12 is installed. The bag supplying device 12 passes bags B (in the present example, flat bags Ba) to gripper pairs (i.e., pairs of grippers 11b) that are intermittently stopped at the first station S1. The bag supplying device 12 shown in FIG. 1 comprises: bag take-out suction cups 12a that each lift a bag B while holding an outer surface of the bag B; and bag transfer chucks 12b that each hold the upper end portion (i.e., the mouth portion) of a bag B that is passed from bag take-out suction cups 12a. Each of gripper pairs (pairs of grippers 11b) stopped intermittently at the first station S1 grips both side portions of a bag B that is passed from the corresponding bag transfer chuck 12b.

At the second station S2, the variety inspection device 13 is installed. The variety inspection device 13 detects the variety of bags B that are intermittently stopped at the second station S2. The specific device configuration and detection method of the variety inspection device 13 are not limited. For instance, the variety inspection device 13 may comprise a bar code reader and may read the “bar code indicating the variety of a bag B” given in advance to each bag B to detect the variety of a bag B. The detection results of the variety inspection device 13 are sent to a control device (not shown in the drawings).

At the third station S3, the mouth opening device 14 is installed. The mouth opening device 14 opens the mouth portions of bags B that are intermittently stopped at the third station S3. The specific device configuration and opening method of the mouth opening device 14 are not limited. The mouth opening device 14 shown in FIG. 1 comprises: pairs of upper suction cups 14a that pull outward outer surfaces of a bag B while holding upper portions of the outer surfaces of the bag B; pairs of lower suction cups 14b that pull outward the outer surfaces of a bag B while holding lower portions of the outer surfaces of the bag B; and air jet nozzles 14c that each blow compressed air through the mouth portion of a bag B toward the inside of the bag B. Each pair of upper suction cups 14a pulls the upper portions of a bag B outward, primarily in order to open the mouth portion of the bag B. Each pair of lower suction cups 14b pulls the lower portions of a bag B outward, primarily in order to shift the bottom portion B3 of the bag B from a folded state to an unfolded state. Each air jet nozzle 14c sprays compressed air toward the inside of a bag B to promote outward expansion of the upper portions and/or lower portions of the bag B.

When opening the mouth portion of a bag B, the distance between upper suction cups 14a forming a pair may be the same as or different from the distance between lower suction cups 14b forming a pair. In a case where the distance between upper suction cups 14a forming a pair is the same as the distance between lower suction cups 14b forming a pair when opening the mouth portion of a bag B, the upper and lower portions of the bag B are pulled outward by the upper suction cups 14a and the lower suction cups 14b to the same degree as each other.

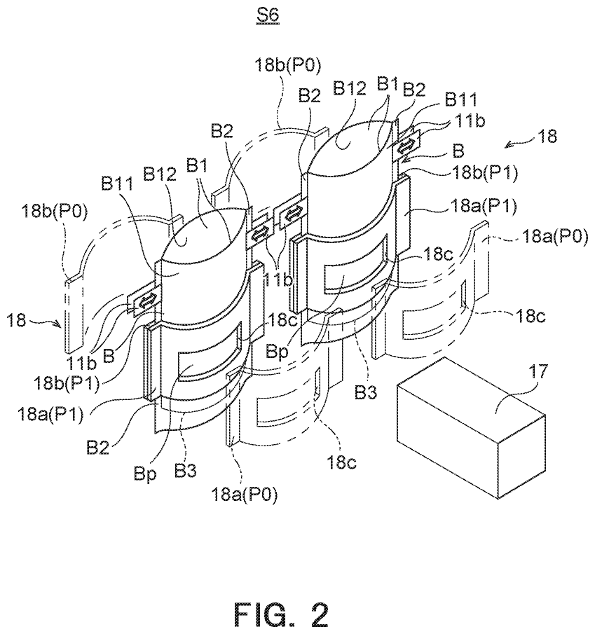

The process of opening the mouth portion of a bag B is performed by the upper suction cups 14a, the lower suction cups 14b and the air jet nozzles 14c working together in this manner. When opening the mouth portion of a bag B, the distance between grippers 11b forming a pair is narrowed in such a manner that the front side body and the back side body of the bag B (i.e., the first lateral face body B11 and the second lateral face body B12 shown in FIG. 2) are bent to the extent that the bag B can be opened.

At the fourth station S4, the solid material feeding device 15 is installed. The solid material feeding device 15 introduces solid contents into the inside of each of bags B that are intermittently stopped at the fourth station S4, through the mouth portions. The solid material feeding device 15 shown in FIG. 1 comprises liftable hoppers that each guide solid contents toward the inside of a bag B. However, the specific configuration of the solid material feeding device 15 is not limited.

At the fifth station S5, a liquid injection device 16 is installed. The liquid injection device 16 introduces liquid contents into the inside of bags B that are intermittently stopped at the fifth station S5, through the mouth portions. The liquid injection device 16 shown in FIG. 1 comprises: a liquid storage tank 16a that stores liquid contents; and injection nozzles 16b that each discharge liquid contents supplied from the liquid storage tank 16a, toward the inside of a bag B. However, the specific configuration of the liquid injection device 16 is not limited.

As described above, in the bagging apparatus 10 shown in FIG. 1, the solid material feeding device 15 and the liquid injection device 16 are provided as a content introduction device to introduce contents inside a bag B, and the “process of introducing contents inside a bag B” is performed at the fourth station S4 and the fifth station S5. In particular, in the present embodiment, the content introduction device (i.e., the solid material feeding device 15 and the liquid injection device 16) is provided to introduce contents into the inside of a bag B through the mouth portion, being in an open state, after the mouth portion of the bag B is opened by the mouth opening device 14 and before printing on the printing surface of the bag B by the printing device 17.

At the sixth station S6, the printing device 17 and the shape forming support unit 18 are installed, and the printing process is performed on bags that are intermittently stopped at the sixth station S6. The information to be printed on a bag B by the printing process is not limited and may be temporal information (e.g., an expiration date of the contents introduced in the bag B or a date of bagging process (i.e., a date of manufacture)), identification information of each bag B, information about the contents, or other characters and/or symbols.

The shape forming support unit 18 works as a curved surface forming device to make at least a part of the printing surface of a bag B curved. The printing device 17 has a curved surface printing function and prints on the printing surface (including a curved surface) of a bag B while the bag B is intermittently stopped in the conveyance route. In the present example, a single printing device 17 performs printing on two bags B that are intermittently stopped at sixth station S6, but two (a plurality of) printing devices 17 may be provided.

The printing method performed by the printing device 17 is not limited, and the printing device 17 can perform the printing process according to an inkjet printing method or a laser printing method, for example. Further, the curved surface printing function of the printing device 17 is a function that performs desired printing on a curved surface, enabling printing of almost the same quality at the center part and at the edge part of a curved surface. The curved surface printing function of the printing device 17 can be realized based on any method. As an example, the printing device 17 may comprise a sensor (e.g., an optical sensor) that can measure the distance to multiple print points included in a printing surface, and may optimize printing on a curved surface by adjusting or changing the printing method based on the information of the measured distance. The printing device 17 may comprise a UV laser marker (e.g., 3-Axis UV laser marker, MD-U series) manufactured by Keyence Corporation.

As described above, in the present embodiment, the printing process on a bag B is performed by the printing device 17 and the shape forming support unit 18 working together. A specific configuration, actions and effects of the printing device 17 and the shape forming support unit 18 are described below (see FIG. 2).

At the seventh station S7, the first heat sealing device 19 is installed, and the sealing process (i.e., a first sealing process) of the mouth portions of bags B that are intermittently stopped at the seventh station S7, is performed by the first heat sealing device 19. At the eighth station S8, the second heat sealing device 20 is installed, and the sealing process (i.e., a second sealing process) of the mouth portions of bags B that are intermittently stopped at the eighth station S8a, is performed by the second heat sealing device 20. Each of the first heat sealing device 19 and the second heat sealing device 20 shown in FIG. 1 comprises pairs of heating plates (in the present example, two pairs of heating plates), and the mouth portion of a bag B is heat-sealed by being sandwiched, pressurized and heated by a pair of heating plates.

At the ninth station S9, the cooling seal device 21 is installed. The cooling seal device 21 performs a cooling and sealing process to stabilize the sealed sections of bags B by cooling the mouth portions of the bags B that are intermittently stopped at the ninth station S9. The cooling seal device 21 shown in FIG. 1 comprises pairs of cooling plates (in the present example, two pairs of cooling plates), and the mouth portion of a bag B is cooled and sealed by being sandwiched, pressurized and cooled by a pair of cooling plates.

At the tenth station S10, the carry-out conveyor 22 is installed. The carry-out conveyor 22 receives bags B (in the present example, product bags Bb with contents sealed inside) that are released from grasping by grippers 11b to drop down at the tenth station S10, and sends the bags B toward the subsequent stage. FIG. 2 is an oblique perspective view showing an example of the printing device 17 and the shape forming support unit 18.

The shape forming support unit 18 shown in FIG. 2 contacts the outer surfaces of bags B to make at least a part of the printing surfaces Bp of the bags B a curved surface. Specifically, the shape forming support unit 18 (the curved surface forming device) exerts a force on a bag B in such a manner that a curved surface of at least a portion of the printing surface Bp has a predetermined shape. The printing device 17 performs printing on the printing surfaces Bp in a state where the shape forming support unit 18 is in contact with the outer surfaces of bags B.

More specifically, the shape forming support unit 18 includes: first support members 18a that each contact the first lateral face body B11 forming the front outer surface of a bag B; and second support members 18b that each contact the second lateral face body B12 forming the back outer surface of a bag B. The contact surface of a first support member 18a that is to contact the first lateral face body B11 has a shape according to a desired shape of the first lateral face body B11 expected in performing the printing process. Similarly, the contact surface of a second support member 18b that is to contact the second lateral face body B12 has a shape according to a desired shape of the second lateral face body B12 expected in performing the printing process.

The contact surface of each first support member 18a shown in FIG. 2 comprises: flat surfaces being to be in contact with both side portions B2; and a curved surface being to be in contact with a curved surface portion of a bag B extending between both the side portions B2, and the curved surface has a shape corresponding to a desired curved surface shape of the first lateral face body B11 (in particular, the front outer surface) in performing the printing process. Similarly, the contact surface of each second support member 18b shown in FIG. 2 comprises: flat surfaces being to be in contact with both side portions B2; and a curved surface being to be in contact with a curved surface portion of a bag B extending between both the side portions B2, and the curved surface has a shape corresponding to a desired curved surface shape of the second lateral face body B12 (in particular, the back outer surface) in performing the printing process. The curved surface in the contact surface of each of the first support members 18a and the second support members 18b may have any shape and may be a curved surface that draws an arc curve or an elliptical curve when being cut in a horizontal direction, for example.

Each printing surface Bp in the example shown in FIG. 2 is included in the front outer surface formed by the first lateral face body B11 of a bag B. However, the printing surface Bp is not limited to the example shown in FIG. 2, and in addition to or instead of the front outer surface, the back outer surface formed by the second lateral face body B12 may contain a printing surface Bp. A printing surface Bp is thus included on at least one of the front outer surface and the back outer surface of a bag B.

Each first support member 18a has a window portion 18c formed by a through hole. As described below, the window portion 18c is provided to expose the printing surface Bp of a bag B, and when contacting a bag B, the first support member 18a contacts a portion of an outer surface of the bag B that does not include the printing surface Bp (in other words, the first support member 18a contacts a part of the front outer surface).

A first support member 18a and a second support member 18b associated with each other are moved symmetrically with respect to the position of a bag B that is intermittently stopped at the sixth station S6, and can be arranged in an evacuation position P0 where they are separated from the bag B, and a support position (a shape forming holding position) P1 where they contact the first lateral face body B11 and the second lateral face body B12 of the bag B. The first support member 18a and the second support member 18b in a state of being positioned in the support position P1 contact and support the first lateral face body B11 (in particular, the front outer surface) and the second lateral face body B12 (in particular, the back outer surface). As a result, in a state where the first support member 18a and the second support member 18b are placed in the support position P1, the front outer surface and the back outer surface of the bag B have shapes corresponding to the contact surfaces of the first support member 18a and the second support member 18b, and in particular, have curved surfaces shape between both the side portions B2.

In the example shown in FIG. 2, the printing process in a bagging method involves the following steps, for example.

When a bag B moves from the fifth station S5 to sixth station S6 together with a corresponding gripper pair (i.e., a pair of grippers 11b), a first support member 18a and a second support member 18b are arranged at the evacuation position P0. The bag B thus enters the space between the first support member 18a and the second support member 18b and is intermittently stopped in that space.

At the point when the bag B is intermittently stopped at the sixth station S6 in this manner, the distance between the grippers 11b has been placed in a distance such that the first lateral face body B11 and the second lateral face body B12 of the bag B are bent outwardly in a projecting fashion in such a manner that the mouth portion B1 is placed in an open state. However, immediately after the bag B is intermittently stopped at sixth station S6, it can be assumed that the distance between the grippers 11b forming a pair is not included in an “allowable spacing range”, the allowable spacing range being such that at least a part of the printing surface Bp has a curved surface shape that the curved surface printing function of the printing device 17 allows. Therefore, the spacing between the grippers 11b forming a pair is adjusted as necessary in such a manner that the spacing between the grippers 11b forming a pair is within the allowable spacing range. Such adjustment of the spacing between the grippers 11b forming a pair may be done under the control of a controller (not shown) before the bag B reaches the sixth station S6 or in a state where the bag B is being positioned at the sixth station S6.

Thus, in the present embodiment, pairs of grippers 11b in addition to the shape forming support unit 18 (i.e., the first support members 18a and the second support members 18b) described above also work as the curved surface forming device to make at least a part of the printing surfaces Bp of bags B curved. Specifically, the spacing between the grippers 11b forming a pair is adjusted as necessary in such a manner that the spacing between those grippers 11b forming a pair is within the allowable spacing range, so that when the printing device 17 prints on the printing surface Bp of a bag B, at least a part of the printing surface Bp has a curved surface shape that the curved surface printing function of the printing device 17 permits.

Then, in a state where the bag B is intermittently stopped at the sixth station S6, the first support member 18a and the second support member 18b are moved from the evacuation position P0 and are placed in the support position P1. As a result, the printing surface Bp of the bag B is exposed to the outside through the window portion 18c, while at least a part of the printing surface Bp forms a curved surface of a desired shape (e.g., a smooth curved surface).

Then, in a state where the printing surface Bp of the bag B has a curved surface of a desired shape by using the first support member 18a and the second support member 18b arranged at the support position P1, printing is performed on the printing surface Bp using the printing device 17. In the present example, the printing surface Bp is present in a portion of the front outer surface formed by the first lateral face body B11 that is exposed through the window portion 18c of the first support member 18a located at the support position P1, and the printing device 17 prints on the printing surface Bp through the window portion 18c. The entirety of a portion of the bag B (in the present example, a portion of the front outer surface) that is exposed through the window portion 18c may constitute the printing surface Bp, or only a part of that portion may constitute the printing surface Bp.

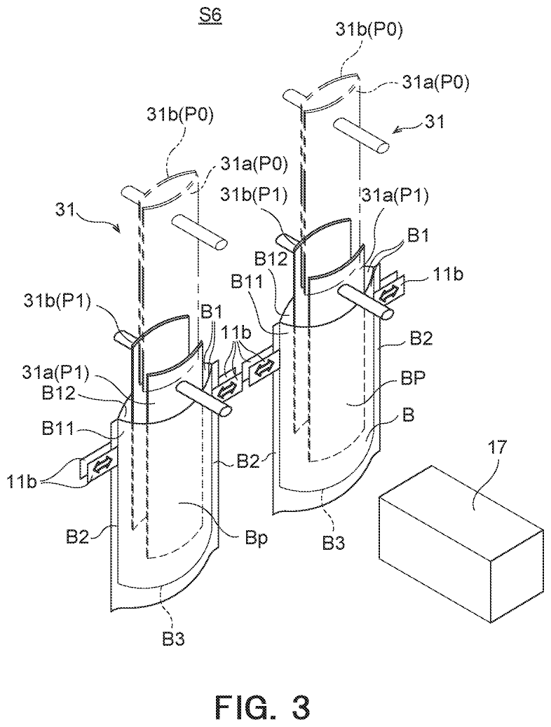

FIG. 3 is an oblique perspective view showing another example of the printing device 17 and the shape forming support unit 31. In the present example, regarding elements, actions and effects in common with the example shown in FIG. 2 described above, the detailed explanation is omitted here.

The shape forming support unit 31 shown in FIG. 3 contacts the inner surface of a bag B to make at least a part of the printing surface Bp curved. The printing device 17 then prints on the printing surface Bp in a state where the shape forming support unit 31 is in contact with the inner surface of the bag B.

More specifically, the shape forming support unit 31 includes: first support members 31a that each contact the first lateral face body B11 of a bag B (in particular, a surface part forming the inner surface of a bag B); and second support members 31b that each contact the second lateral face body B12 of a bag B (in particular, a surface part forming the inner surface of a bag B). The contact surface of each first support member 31a that is to contact the first lateral face body B11 has a shape according to a shape of the first lateral face body B11 expected in performing the printing process. Similarly, the contact surface of each second support member 31b that is to contact the second lateral face body B12 has a shaped according to a shape of the second lateral face body B12 expected in performing the printing process.

The contact surface of each first support member 31a shown in FIG. 3 has a curved surface that contacts the curved surface portion of a bag B extending between both the side portions B2, and said curved surface has a shape according to a desired curved surface shape of the first lateral face body B11 (in particular, the front outer surface) in performing the printing process. Similarly, the contact surface of each second support member 31b shown in FIG. 3 has a curved surface that contacts the curved surface portion of a bag B extending between both the side portions B2, and said curved surface has a shape according to a desired curved shape of the second lateral face body B12 (in particular, the back outer surface) in performing the printing process.

In the example shown in FIG. 3, the printing process in a bagging method involves the following steps, for example.

In a state where a first support member 31a and a second support member 31b are in the evacuation position P0, a bag B moves from the fifth station S5 together with a corresponding gripper pair (a pair of grippers 11b) and is intermittently stopped directly below (in the vertical direction) the first support member 31a and the second support member 31b.

Then, the spacing between the grippers 11b forming a pair is adjusted as necessary in such a manner that the spacing between the grippers 11b forming a pair is within the allowable spacing range.

Then, in a state where the bag B being intermittently stopped at the sixth station S6, the first support member 31a and the second support member 31b are moved from the evacuation position P0 and are placed in the support position P1. In the example shown in FIG. 3, the first support member 31a and the second support member 31b move directly down from the evacuation position P0 to enter the inner space of the bag B through the open mouth portion B1, and after that, move in the direction away from each other (in a horizontal direction) in a state where being partially in the inner space of the bag B, to be placed in the support position P1.

The first lateral face body B11 and the second lateral face body B12 of the bag B are pressed from the inside of the bag B by the first support member 31a and the second support member 31b, resulting in the printing surface Bp of the bag B having a desired curved shape.

Then, in a state where the bag B is held by the first support member 31a and the second support member 31b positioned at the support position P1 so that the printing surface Bp has a curved surface of a desired shape, printing is performed on the printing surface Bp (including a curved surface) using the printing device 17.

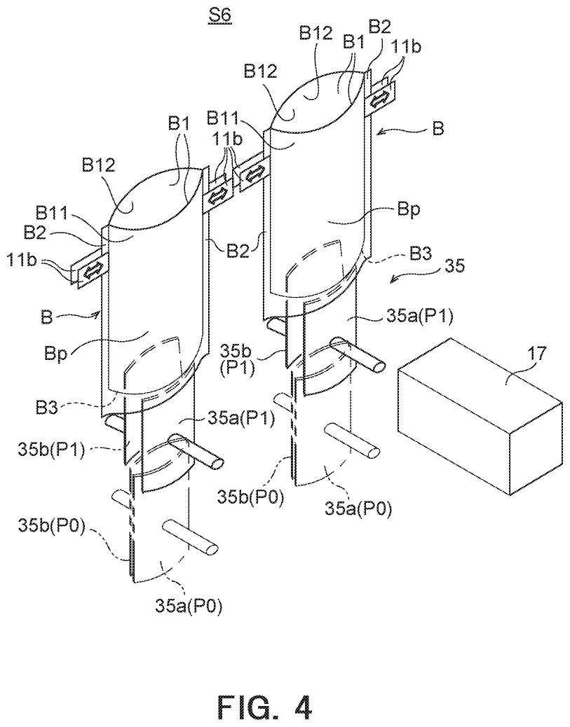

FIG. 4 is an oblique perspective view showing another example of the printing device 17 and the shape forming support unit 35. In the present example, regarding elements, actions and effects in common with the examples shown in FIGS. 2 and 3 described above, the detailed explanation is omitted here.

The shape forming support unit 35 shown in FIG. 4 places the bottom portion B3 of a bag B in a predetermined unfolded state to make at least a part of the printing surface Bp curved. The printing device 17 then prints on the printing surface Bp in a state where the bottom portion B3 of the bag B is placed in the predetermined unfolded state.

More specifically, the shape forming support unit 35 includes: first support members 35a that each contact the first lateral face body B11 of a bag B (in particular, a surface part forming the inner face of the lower end portion); and second support members 35b that each contact the second lateral face body B12 of a bag B (in particular, a surface part forming the inner face of the lower end portion). The contact surface of each first support member 35a shown in FIG. 4 that contacts the first lateral face body B11 has a curved surface similar to the contact surface of the first support members 31a shown in FIG. 3 described above. Similarly, the contact surface of each second support member 35b shown in FIG. 4 that contacts the second lateral face body B12 has a curved surface similar to the contact surface of the second support members 31b shown in FIG. 3 described above.

In the example shown in FIG. 4, the printing process in a bagging method involves the following steps, for example.

In a state where a first support member 31a and a second support member 31b are in the evacuation position P0, a bag B moves from the fifth station S5 together with a corresponding gripper pair (a pair of grippers 11b) and is intermittently stopped directly above the first support member 35a and the second support member 35b.

Then, the spacing between the grippers 11b forming a pair is adjusted as necessary in such a manner that the spacing between the grippers 11b forming a pair is within the allowable spacing range.

Then, in a state where the bag B is intermittently stopped at the sixth station S6, the first support member 35a and the second support member 35b are moved from the evacuation position P0 and are placed in the support position P1. In the example shown in FIG. 4, the first support member 35a and the second support member 35b move directly upward (in the height direction) from the evacuation position P0 to enter the lower space demarcated by the first lateral face body B11, the second lateral face body B12 and the bottom portion B3 of the bag B, and after that, move in the direction away from each other (in a horizontal direction) in a state where being partially in the lower space of the bag B, to be placed in the support position P1.

As a result, the inner surface of the lower end of the first lateral face body B11 and the inner surface of the lower end of the second lateral face body B12 of the bag B are pressed outward by the first support member 35a and the second support member 35b, so that the printing surface Bp of the bag B forms a curved surface having a desired shape.

Then, in a state where the bag B is held by the first support member 35a and the second support member 35b arranged at the support position P1 in such a manner that the printing surface Bp has a curved surface having a desired shape, printing is performed on the printing surface Bp (including a curved surface) using the printing device 17.

As explained above, according to the bagging apparatuses 10 (in particular, the printing device 17 and the shape forming support unit 18) shown in FIGS. 1 to 4 described above and the bagging methods, the printing process on a bag B is performed after the mouth portion B1 of the bag B is opened. Therefore, even if it is not possible to perform the printing process on a bag B before opening the mouth portion B1 of the bag B, the printing process on a bag B can be properly performed according to the bagging apparatuses 10 shown in FIGS. 1 to 4.

Therefore, since there is no need to install the printing device 17 upstream from the bagging apparatus 10 separately from the bagging apparatus 10, increase in sizes and costs of the whole apparatus can be reduced, and the bagging apparatus 10 including the printing device 17 can be installed in a limited space. In addition, the conventionally required “manual printing process on a bag B performed prior to a bagging process” is not necessary, which can reduce the workload and improve the productivity of product bags Bb.

Further, the printing process on a bag B is performed after opening the mouth portion B1 of the bag B and after introducing the contents into the bag B. Therefore, if the mouth portion B1 of a bag B has not been properly opened or the contents have not been properly introduced into a bag B, such a bag B (a defective bag) can be released from a corresponding gripper pair (a pair of grippers 11b) and discharged from the bagging apparatus 10 before the printing process on the bag B (a defective bag) is performed. Bags B discharged in this manner can also be supplied to the bagging apparatus 10 for reuse, and in particular, since such discharged bags B are discharged before the printing process, the discharged bags B may be supplied to the bagging apparatus 10 for reuse on or after the day following the date of discharge.

### Variant Examples

The shape forming support unit 18 shown in FIG. 2 includes a first support member 18a and a second support member 18b, but only one support member (e.g., only the first support member 18a) may be provided. Similarly, regarding the shape forming support unit 31 shown in FIG. 3 and the shape forming support unit 35 shown in FIG. 4, only one support member (e.g., only the first support member 31a and only the first support member 35a) may be provided. Further, instead of a pair of first and second support members 31a, 31b shown in FIG. 3, a single columnar body (e.g., a columnar body having a horizontal cross-section surface of an elliptical or oval shape) may be provided as the shape forming support unit 31. Similarly, instead of a pair of first and second support members 35a, 35b shown in FIG. 4, a single columnar body may be provided as the shape forming support unit 35. Such a single columnar body may have a horizontal cross-section surface of any shape, and at least a part of the periphery (edge) of the horizontal cross-section surface may have, for example, a circular arc, an elliptical arc, another curved line, and/or a straight line.

Further, the curved surface forming device that makes at least a portion of the printing surface Bp of a bag B curved, may also include gripping members that grip the first lateral face body B11 and/or the second lateral face body B12 of the bag B, instead of or in addition to the above-described support members that contact the bag B to exert a force on the bag B.

Further, in the examples shown in FIGS. 2 through 4 described above, the printing process with the printing device 17 is performed only on the front outer surface of a bag B; however, the printing process with the printing device 17 may be performed only on the back outer surface of a bag B, or the printing process with the printing device 17 may be performed on both the front outer surface and the back outer surface of a bag B.

Further, the printing device 17 and the curved surface forming device (see the shape forming support unit 18 described above) may be located downstream from the mouth opening device 14 and upstream from the content introduction device (i.e., the solid material feeding device 15 and the liquid injection device 16). For example, in a case where the shape forming support unit 31 enters the inner space of a bag B as shown in FIG. 3, it is preferable that the printing process by the printing device 17 and the shape forming support unit 31 is performed prior to the content introduction process that introduces the contents into the inner space.

Further, the bagging apparatus 10 and the bagging method of the present embodiment can also be applied to apparatuses and methods that introduce contents into spouted bags (see, for example, the apparatus disclosed in Japanese patent application publication No. 2001-341708). The apparatus and the method for introducing contents to a spouted bag do not require the mouth opening device 14 and the mouth opening process for opening the mouth portion of a bag B described above. For example, contents may be introduced inside a bag via a spout that is attached to the bag, and a cap may be attached to the tip opening portion of the spout after the content introduction is completed. After the contents are introduced into a bag B through a spout, the printing process on said bag B may be performed.

Further, in the examples shown in FIGS. 1 to 4 described above, the conveyance device 11 conveys bags B intermittently, but the bagging apparatuses 10 and the bagging methods described above can also be applied to continuous transfer type bagging apparatuses and bagging methods that convey bags B continuously (i.e., non-intermittently) (see, for example, the apparatus disclosed in Japanese patent application publication No. 2001-72004). In this case, the printing process using the printing device 17 and the shape forming support unit (e.g., a first support member 18a and a second support member 18b shown in FIG. 2) may be performed on a bag B while the printing device 17 and the shape forming support unit are continuously moved together with the bag B in a certain section (i.e., a printing process section) of the conveyance route for the bag B. In this case, after the printing process on a bag B is completed, the printing device 17 is returned to the starting position of the printing process section for the printing process for a next bag B.

Further, the bagging apparatus 10 and the bagging method of the present embodiment can also be applied to horizontal type bagging machines and bagging methods that introduce the contents into a bag B placed in a lying posture state (i.e., a bag B whose mouth portion is facing in a lateral direction (i.e., a horizontal direction) (See, for example, the apparatus disclosed in Japanese patent application publication No. 6-144403).

In the bagging apparatuses 10 shown in FIGS. 1 through 4 described above, two bags B are intermittently stopped at each station at a time, but only one bag B may be stopped at each station at a time, or three or more bags B may be stopped at each station at a time.

Further, bags B to which the bagging apparatus 10 and the bagging method of the present embodiment can be applied, are not limited to self-standing bags.

It should be noted that the embodiments and the variant examples disclosed in the present specification are shown merely as examples in all respects and are not to be construed as limiting. Regarding the above-described embodiments and variant examples, omissions, replacements and modifications are possible in various forms without departing from the scope and intent of the appended claims. For instance, the embodiments and variant examples described above may be combined in whole or in part, and embodiments other than those described above may be combined with the embodiments or variant examples described above. Further, the effects of the present disclosure described in the present specification are shown merely as examples, and other effects may be brought about.

Technical categories embodying the technical ideas described above are not limited. For instance, the above-described technical ideas may be embodied by computer programs causing a computer to execute one or more procedures (steps) included in a method for manufacturing or using the devices described above. Further, the above technical ideas may also be embodied by a computer-readable non-transitory recording medium in which such computer programs are recorded.

### Additional Notes

The present disclosure may also offer the following configurations.

### Aspect 1

A bagging method including the steps of:
introducing a content into an inside of a bag;
making at least a portion of a printing surface of the bag curved; and
performing printing on the printing surface including a curved surface with use of a printing device having a curved surface printing function.

### Aspect 2

The bagging method as defined in aspect 1, including the step of opening a mouth portion of the bag,
wherein the content is introduced into the inside of the bag through the mouth portion being in an open state after the mouth portion is opened and before the printing is performed on the printing surface.

### Aspect 3

The bagging method as defined in aspect 1 or 2, wherein the curved surface has a predetermined shape by a curved surface forming device exerting a force on the bag.

### Aspect 4

The bagging method as defined in any one of aspects 1 to 3,
wherein the bag is intermittently conveyed, and
wherein the printing on the printing surface is performed while the bag is intermittently stopped.

### Aspect 5

The bagging method as defined in any one of aspects 1 to 4, wherein both side portions of the bag are held by a pair of holding devices in such a manner that the bag is held in a suspended state by the pair of holding devices.

### Aspect 6

A bagging apparatus comprising:
a content introduction device that introduces a content into an inside of a bag;
a curved surface forming device that makes at least a part of a printing surface of the bag curved; and
a printing device that has a curved surface printing function and performs printing on a printing surface that includes the curved surface.

### Aspect 7

The bagging apparatus as defined in aspect 6, comprising a mouth opening device that opens a mouth portion of the bag,
wherein the content introduction device introduces the content into the inside of the bag through the mouth portion being in an open state after the mouth portion is opened by the mouth opening device and before the printing is performed on the printing surface by the printing device.

### Aspect 8

8. The bagging apparatus as defined in aspect 6 or 7, comprising holding devices forming a pair that hold both side portions of the bag, a distance between the holding devices forming a pair being variable, the printing surface of the bag being deformed depending on the distance between the holding devices forming a pair,
wherein the curved surface forming device includes the holding devices forming a pair, and the distance between the holding devices forming a pair is included in an allowable spacing range when the printing device performs the printing on the printing surface in such a manner that at least a part of the printing surface has a curved surface shape that the curved surface printing function allows.

### Aspect 9

The bagging apparatus as defined in any one of aspects 6 to 8,
wherein the curved surface forming device has a shape forming support unit that contacts an outer surface of the bag to make at least a portion of the printing surface the curved surface, and
wherein the printing device performs the printing on the printing surface in a state where the shape forming support unit is in contact with the outer surface of the bag.

### Aspect 10

The bagging apparatus as defined in any one of aspects 6, 8 and 9,
wherein the curved surface forming device has a shape forming support unit that contacts an inner surface of the bag to make at least a part of the printing surface the curved surface, and
wherein the printing device performs the printing on the printing surface in a state where the shape forming support unit is in contact with the inner surface of the bag.

### Aspect 11

The bagging apparatus as defined in any one of aspects 6 to 10,
wherein the bag has a bottom portion that is able to be unfolded, the printing surface of the bag being deformed according to an unfolded state of the bottom portion,
wherein the curved surface forming device has a shape forming support unit that places the bottom portion of the bag in a predetermined unfolded state to make at least a part of the printing surface the curved surface, and
wherein the printing device performs the printing on the printing surface in a state where the bottom portion of the bag is placed in the predetermined unfolded state.

### Aspect 12

12. The bagging apparatus as defined in any one of aspects 9 to 11,
wherein the shape forming support unit includes: a first support member that contacts a first lateral face body forming a front outer surface of the bag; and a second support member that contacts a second lateral face body forming a back outer surface of the bag, and
wherein the printing surface is included in at least one of the front outer surface and the back outer surface of the bag.

### Aspect 13

The bagging apparatus as defined in any one of aspects 6 to 12, comprising a conveyance device that intermittently conveys the bag along a conveyance route that includes a curved path at least in part,
wherein the printing device performs the printing on the printing surface while the bag is intermittently stopped in the conveyance route.

### Aspect 14

The bagging apparatus as defined in any one of aspects 6 to 13, comprising holding devices forming a pair that hold both side portions of the bag in such a manner that the bag is held in a suspended state.

1. A bagging method including the steps of:
introducing a content into an inside of a bag;
making at least a portion of a printing surface of the bag curved; and
performing printing on the printing surface including a curved surface with use of a printing device having a curved surface printing function.

2. The bagging method as defined in claim 1, including the step of opening a mouth portion of the bag,
wherein the content is introduced into the inside of the bag through the mouth portion being in an open state after the mouth portion is opened and before the printing is performed on the printing surface.

3. The bagging method as defined in claim 1, wherein the curved surface has a predetermined shape by a curved surface forming device exerting a force on the bag.

4. The bagging method as defined in claim 1,
wherein the bag is intermittently conveyed, and
wherein the printing on the printing surface is performed while the bag is intermittently stopped.

5. The bagging method as defined in claim 1, wherein both side portions of the bag are held by a pair of holding devices in such a manner that the bag is held in a suspended state by the pair of holding devices.

6. A bagging apparatus comprising:
a content introduction device that introduces a content into an inside of a bag;
a curved surface forming device that makes at least a part of a printing surface of the bag curved; and
a printing device that has a curved surface printing function and performs printing on the printing surface that includes the curved surface.

7. The bagging apparatus as defined in claim 6, comprising a mouth opening device that opens a mouth portion of the bag,
wherein the content introduction device introduces the content into the inside of the bag through the mouth portion being in an open state after the mouth portion is opened by the mouth opening device and before the printing is performed on the printing surface by the printing device.

8. The bagging apparatus as defined in claim 6, comprising holding devices forming a pair that hold both side portions of the bag, a distance between the holding devices forming a pair being variable, the printing surface of the bag being deformed depending on the distance between the holding devices forming a pair,
wherein the curved surface forming device includes the holding devices forming a pair, and the distance between the holding devices forming a pair is included in an allowable spacing range when the printing device performs the printing on the printing surface in such a manner that at least a part of the printing surface has a curved surface shape that the curved surface printing function allows.

9. The bagging apparatus as defined in claim 6,
wherein the curved surface forming device has a shape forming support unit that contacts an outer surface of the bag to make at least a portion of the printing surface the curved surface, and
wherein the printing device performs the printing on the printing surface in a state where the shape forming support unit is in contact with the outer surface of the bag.

10. The bagging apparatus as defined in claim 6,
wherein the curved surface forming device has a shape forming support unit that contacts an inner surface of the bag to make at least a part of the printing surface the curved surface, and
wherein the printing device performs the printing on the printing surface in a state where the shape forming support unit is in contact with the inner surface of the bag.

11. The bagging apparatus as defined in claim 6,
wherein the bag has a bottom portion that is able to be unfolded, the printing surface of the bag being deformed according to an unfolded state of the bottom portion,
wherein the curved surface forming device has a shape forming support unit that places the bottom portion of the bag in a predetermined unfolded state to make at least a part of the printing surface the curved surface, and
wherein the printing device performs the printing on the printing surface in a state where the bottom portion of the bag is placed in the predetermined unfolded state.

12. The bagging apparatus as defined in claim 9,
wherein the shape forming support unit includes: a first support member that contacts a first lateral face body forming a front outer surface of the bag; and a second support member that contacts a second lateral face body forming a back outer surface of the bag, and
wherein the printing surface is included in at least one of the front outer surface and the back outer surface of the bag.

13. The bagging apparatus as defined in claim 10,
wherein the shape forming support unit includes: a first support member that contacts a first lateral face body forming a front outer surface of the bag; and a second support member that contacts a second lateral face body forming a back outer surface of the bag, and
wherein the printing surface is included in at least one of the front outer surface and the back outer surface of the bag.

14. The bagging apparatus as defined in claim 11,
wherein the shape forming support unit includes: a first support member that contacts a first lateral face body forming a front outer surface of the bag; and a second support member that contacts a second lateral face body forming a back outer surface of the bag, and
wherein the printing surface is included in at least one of the front outer surface and the back outer surface of the bag.

15. The bagging apparatus as defined in claim 6, comprising a conveyance device that intermittently conveys the bag along a conveyance route that includes a curved path at least in part,
wherein the printing device performs the printing on the printing surface while the bag is intermittently stopped in the conveyance route.

16. The bagging apparatus as defined in claim 6, comprising holding devices forming a pair that hold both side portions of the bag in such a manner that the bag is held in a suspended state.
